(19) United States
(12) Patent Application Publication
(10) Pub. No.: US 2006/0005366 A1
(43) Pub. Date: Jan. 12, 2006

(54) Brake clip removal tool

(75) Inventor: Randall J. Ploeger, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 10/887,704

(22) Filed: Jul. 9, 2004

(51) Int. Cl. B23P 19/04; B23P 19/00

(52) U.S. Cl. 29/225; 29/426.5

(57) ABSTRACT

A tool for removal of U-shaped brake spring or clip associated with a drum brake assembly, includes a foot, which will engage against one leg of the brake spring, and a side arm, which will engage against said leg of the clip or spring, and which will thereby upon pivotal motion of the tool, effect compression of the spring to permit removal thereof from a retention pin.

### BACKGROUND OF THE INVENTION

In a principal aspect, the present invention relates to a tool, and a method of use of the tool, for removal of a U-shaped metal brake clip or spring of the type commonly utilized in the assembly of a motor vehicle drum brake.

Various motor vehicles utilize a special U-shaped metal clip or spring to facilitate attachment of a drum shoe in a drum brake assembly. Typically, the clip or spring has a U shape with first and second legs having slots that fit over a retention pin projecting from the housing for the drum brake assembly. The legs are biased outwardly from one another by a connecting crown. The clip or spring is thus positioned over the drum shoe and engaged with the retention pin by sliding the clip so that the slots of the clip legs fit around the retention pin to thereby hold the drum shoe of the drum brake assembly in position within the housing of the assembly. Obtaining access to and then removing the brake clip or brake spring from the retention pin to release the brake shoe is a difficult task because of the shape or configuration of the brake clip and the limited space in which the clip is positioned. Consequently, there is a need for a tool which will enable removal of such brake clips or brake springs in an efficient manner.

### SUMMARY OF THE INVENTION

Briefly, the present invention comprises a tool for removal of a U-shaped brake retention spring from a brake shoe retention pin wherein the spring is of the type that includes first and second spaced legs connected by a crown and each of the legs includes a slot for receipt of the retention pin. The tool comprises an elongate handle having a longitudinal axis with a manual grip end and a spring engagement end. Located at the spring engagement end is a foot which extends transversely or laterally to the longitudinal axis and is spaced from the end of the handle to define a generally transverse slot between the foot and the end of the handle. Thus, the foot may be fitted between the legs of the brake spring and positioned as a fulcrum against one of those legs. A first side arm is affixed to the handle and extends in the direction of the longitudinal axis toward the foot. The first side arm may be positioned against the second leg of the brake spring and engage that leg to effect biasing of the leg upon pivotal motion of the handle about the fulcrum. Thus, a brake spring or brake clip, which is mounted on a retention pin may be engaged by the tool in a manner which will enable biasing the legs of the brake spring toward one another enabling the spring to thereby be removed by sliding motion from the retention pin. Upon such removal from the retention pin, of course, the brake shoe associated with the brake drum assembly may be removed from the assembly for replacement, repair or the like.

Thus it is an object of the invention to provide an improved tool for removal of a U-shaped brake spring from a brake shoe retention pin.

It is a further object of the invention to provide a brake spring removal tool which is compact, easy to use, rugged, inexpensive, and capable of utility for removal of brake spring clips or U-shaped clips having a variety of sizes and configurations.

Yet another object of the invention is to provide a method for removal of a brake spring from a brake shoe retention pin which utilizes a unique tool.

A further object of the invention is to provide a brake spring removal tool which may be utilized to effect removal of a brake spring clip from a brake assembly wherein the tool may be reversed in orientation to accommodate and effect removal of brake spring clips by engagement of the brake spring from either side of the brake spring.

Another object of the invention is to provide a tool which may be used to engage and compress the legs of a U-shaped clip or spring located in a restricted space.

These and other objects, advantages, and features of the invention will be set forth in the detailed description which follows.

### BRIEF DESCRIPTION OF THE DRAWING

In the detailed description which follows, reference will be made to the drawing comprised of the following figures:

FIG. 1 is a plan view of the tool of the invention;

FIG. 2 is a side view of the tool of FIG. 1;

FIG. 3 is an exploded isometric view of the tool of FIG. 1; and

FIG. 4 is an isometric view of the tool of FIG. 1 wherein the tool is positioned for engagement and removal of a drum brake retention spring;

FIG. 5 is an enlarged isometric view of the tool of FIG. 4 as it is engaged with a retention spring; and

FIG. 6 is an enlarged isometric view of the tool of FIG. 5 depicting use of the tool for removal of a drum brake retention spring.

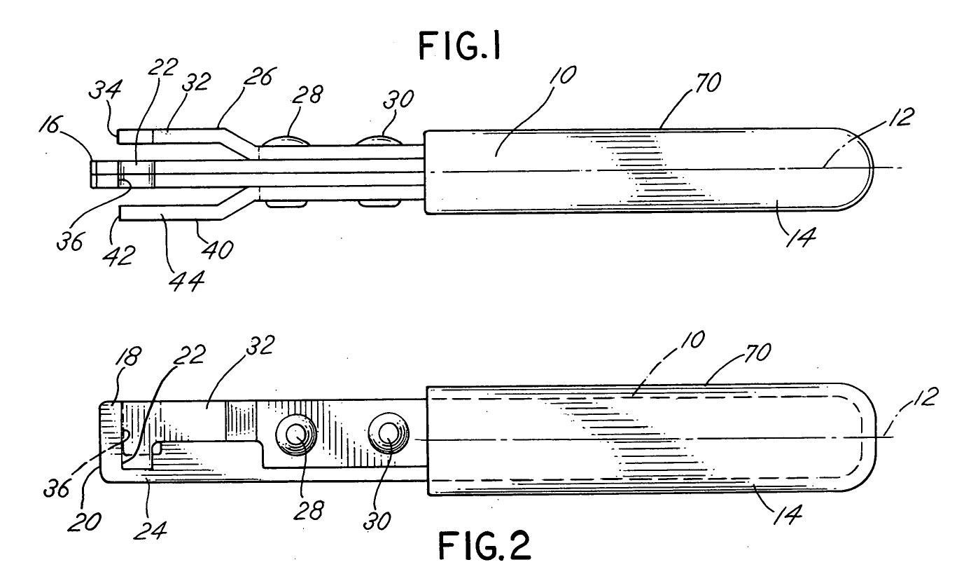

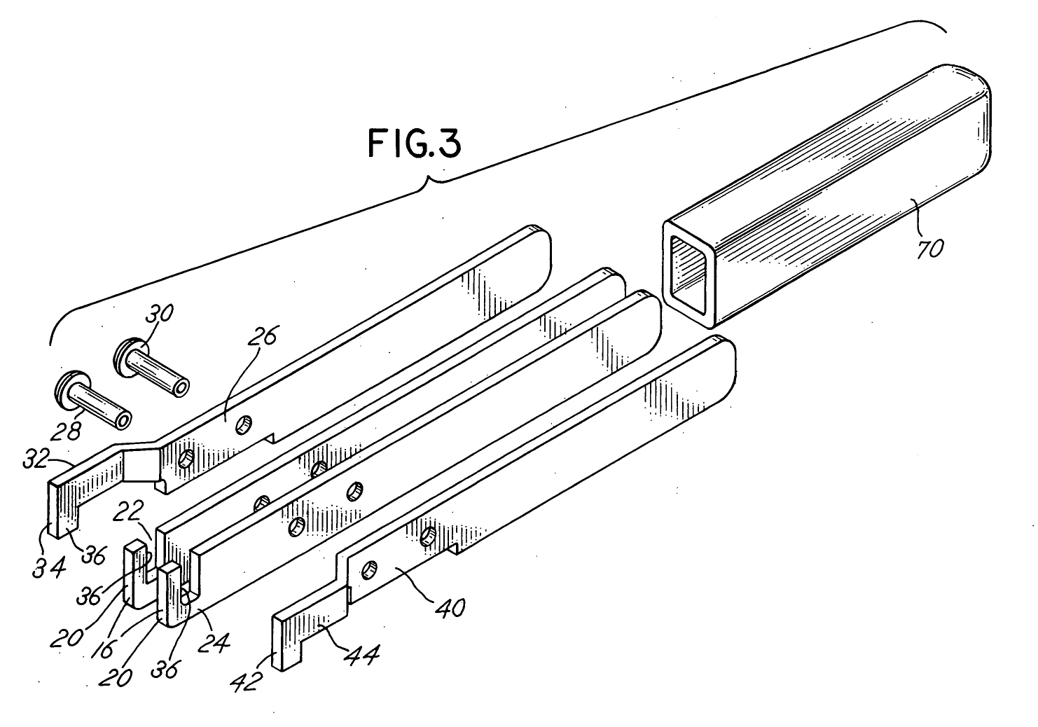

### DESCRIPTION OF THE PREFERRED EMBODIMENT

Referring to the figures, the tool of the invention is comprised of an elongate handle 10 which includes an elongate or longitudinal axis 12 with a manual grip end 14 and a spring engagement end 16. Typically, the handle 10 is comprised of at least one or more thicknesses of a sheet metal material which is cut or formed by stamping, laser cutting or another metal forming process. The handle 10 further includes a foot 18 at its distal or spring engagement end 16. The foot 18 extends transversely or laterally from the axis 12 and comprises an extension of the handle 10. The foot 18 defines a planar bottom surface or face 20. The foot 18 further defines a slot or opening 22 between the foot 18 and the main body of the elongate handle 10. Slot 22 defines an internal fulcrum surface or face 36 generally parallel to end or bottom face 20. A bridge connection section 24 extending along a lateral side of the handle joins or connects the foot 18 with the elongate handle 10. In the embodiment depicted, the handle 10 at the manual grip end includes a sleeve 70 which facilitates manual gripping of the handle 10.

The tool further includes a cantilever first side arm 26 which is attached to the handle 10 by means of first and second rivets 28, 30. The first side arm 26 includes a planar section 32 which is generally parallel to and spaced from the outside flat plane or surface of the handle 10. The planar section 32 includes an end face 34 which is generally aligned with distal face or fulcrum surface 36 of slot 22. The planar section 32 thus overlies the slot 22 and is spaced from the handle 10 but parallel thereto. The arm 26 is also configured so that the end portion of planar section 32 of the arm 26 includes or defines a foot having the end face 34 generally parallel to end face 20 of the handle 10 and distal face 36 of slot 22.

A second cantilever side arm 40 is attached by the rivets 28, 30 to the opposite side of the handle 10 and comprises a mirror image of the first side arm 26. Thus, the second side arm 40 includes an end face 42 and a second section or portion 44 generally parallel to and spaced from the handle 10. The sections or portions 44 and 32 are preferably equally spaced from the sides of the handle 10. However, the spacing may be varied to accommodate clips of different size for example.

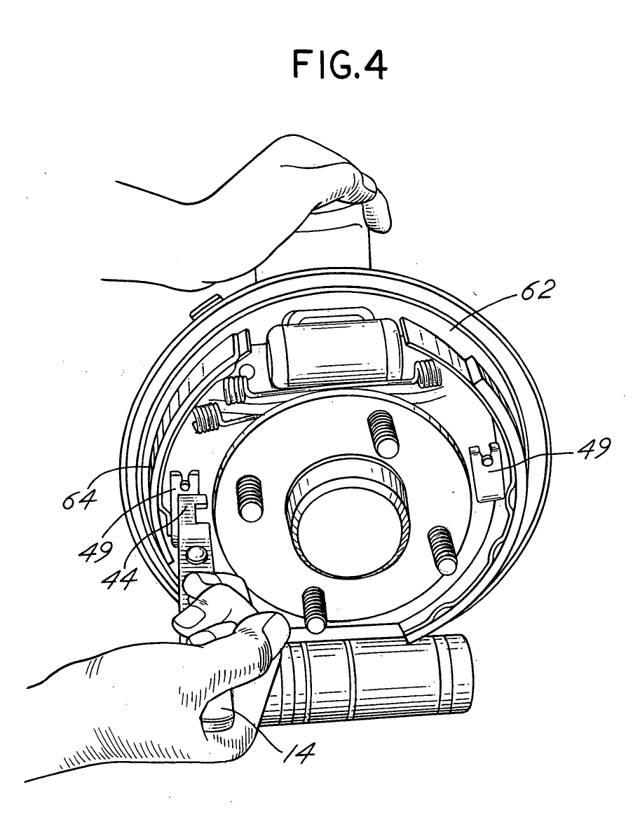

In use, as depicted for example in FIGS. 4, 5 and 6, the handle 10 and, more particularly, the foot 18 of the handle 10 is inserted between legs 50 and 52 of a brake retention spring 49 of a type wherein the legs 50, 52 are connected by a crown 54. Each of the legs 50 and 52 include a longitudinal slot 56 and 58. The slots 56 and 58 overlie one another and are provided to slidably fit on a headed pin 60 which projects from the drum brake housing 62 and serves to retain a brake shoe 64 affixed or mounted to the housing 62. In order to remove the brake shoe 64 from the housing 62 it is necessary to bias the spring or brake clip 49 in a manner which will move the respective legs 50, 52 toward one another so that the spring or brake clip 49 may be slidably removed from the pin 60. This may be effected by placing the notch or slot 22 over the top leg 50 of the brake spring 49 so that the foot 18 will fit in a manner whereby the fulcrum surface 36 may engage the underside of upper leg 50. The upper leg 50 may then also be engaged by the planar surface 34 associated with the first arm 26. Then as the first arm 26 is brought to bear against the first leg 50 upon rotational movement of handle 10, the legs 50, 52 will be moved toward one another thereby enabling the tool and, more particularly, the handle 10 to be manipulated so as to withdraw the spring or clip 49 from the headed pin 60.

Because of the design of the tool, utilizing first and second side arms 26, 40, the tool may be used in a reverse sense. That is, the tool may be fitted against either side of the brake spring or clip 49 by inserting the foot 18, for example, in the manner depicted in FIG. 6, or by inserting the foot 18 in the opposite sense so that the free end of the foot 18 will project outwardly in the drawing of FIG. 6. In such an instance, the fulcrum surface or distal surface 36 will remain active as a fulcrum and the foot engaging surface 34 of the first arm 26 will not initially engage the legs that are free. Rather, the end surface 42 of side arm 40 will engage the leg 50 to effect compression of the legs 50 and 52 toward one another to facilitate removal of the spring or clip 49 from headed pin 60.

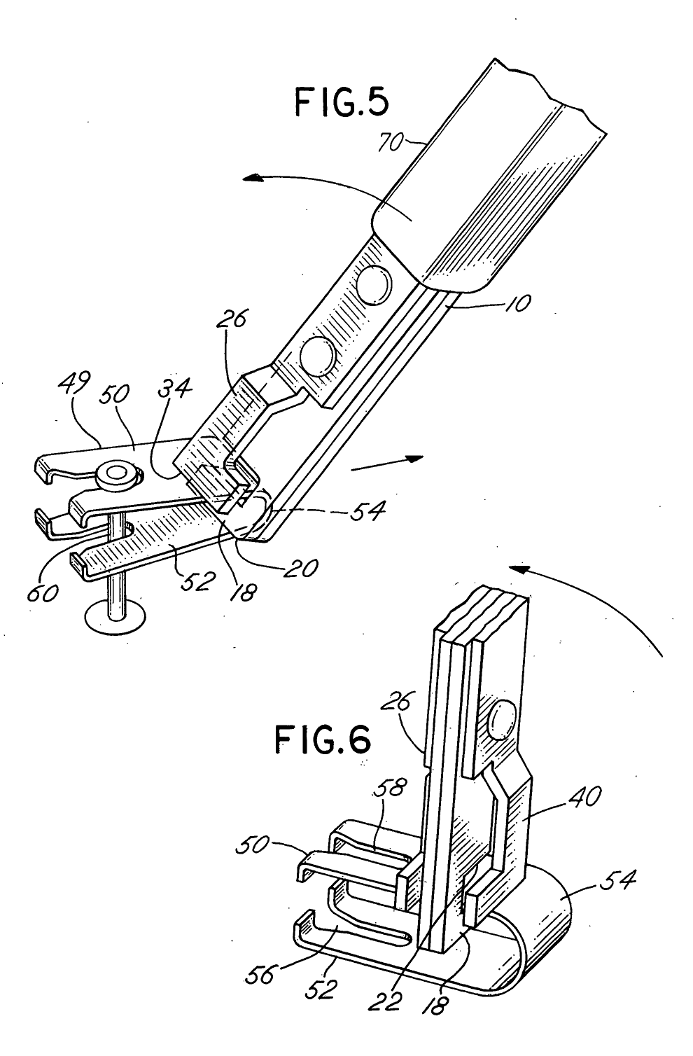

In use, the tool may be utilized to bias or bend brake clips of the type depicted by insertion of the tool from either side of the brake clip 49. The particular configuration of the end of the handle 10, the size and dimension of the foot 18, the configuration of the side elements or side arms 26, 40, may all be varied to provide a tool having various design alternatives, but in each instance a fulcrum is provided to fit against one of the legs of the spring and a biasing surface against the other spring. Pivoting or twisting movement of the handle 10, for example, in the direction of the arrow in FIG. 5 and FIG. 6 effects clip compression.

It is to be noted that the tool may also be utilized when reinstalling the clip 49. That is, the tool may be utilized to manipulate the brake clip or brake spring 49 so that it will be appropriately compressed so as to fit over a retention pin 60. The tool may then be removed from engagement with the clip or spring 49.

Thus, various alternatives in the construction of the invention are possible, including many of those described herein. The invention therefore is to be limited only by the following claims and equivalents thereof.

What is claimed is:

1. A tool for removal of a U-shaped brake spring from a brake shoe retention pin, said spring including first and second spaced legs connected by a crown, each leg including a slot for receipt of the retention pin, said tool comprising, in combination:
an elongate handle having a longitudinal axis with a manual grip end and a spring engagement end, said spring engagement end including a foot transverse to the longitudinal axis and spaced from the end of the handle with a generally transverse slot between the foot and the end of the handle for receipt of one leg of a brake spring when the foot is positioned intermediate spaced legs of a spring, the slot including a surface comprising a fulcrum when engaged against said one leg of a brake spring; and
a first side arm affixed to the handle and extending in the direction of the axis toward the foot, said first side arm including a side arm end face for engaging the said one leg and biasing the spring upon pivotal motion of the handle about the slot surface.

2. The tool of claim 1 wherein the handle comprises a planar member and the first side arm comprises a cantilever plate attached to the handle, said cantilever plate includes a planar plate section parallel to and spaced from the handle.

3. The tool of claim 1 or 2 including a second side arm attached to the handle on the opposite side from the first side arm.

4. The tool of claim 1 or 2 wherein the outside end face and the side arm end face are each generally flat planar and parallel.

5. The tool of claim 1 or 2 wherein the side arm end face is positioned along the longitudinal axis intermediate the outside end face and the manual grip end of the handle.

6. A method for release of a U-shaped brake spring from a brake shoe retention pin, said brake spring including first and second spaced legs connected by a crown, each leg including a slot for receipt of the retention pin, said method comprising the steps of:
a. positioning a tool having an elongate handle having a longitudinal axis with a manual grip end and a spring engagement end, said spring engagement end including a foot transverse to the longitudinal axis and spaced from the end of the handle with a generally transverse slot between the foot and the end of the handle for receipt of one leg of a brake spring when the foot is positioned intermediate spaced legs of a spring, the slot including a face comprising a fulcrum when engaged against the one leg of a brake spring; and a first side arm affixed to the handle and extending in the direction of the axis toward the foot, said first side arm including a side arm end face for engaging the said one leg and biasing the spring upon pivotal motion of the handle about the slot face fulcrum with the foot positioned intermediate the first and second legs of the spring, the slot face positioned on said one leg and the side arm end face positioned on said one leg; and
b. pivoting the handle about the fulcrum to impinge the side arm end face against the one leg and bend the spring to release the spring from the pin.
